(19) United States
(12) Patent Application Publication
(10) Pub. No.: US 2024/0152611 A1
(43) Pub. Date: May 9, 2024

(54) DETERMINATION DEVICE, DETERMINATION METHOD, AND DETERMINATION PROGRAM

(71) Applicant: NIPPON TELEGRAPH AND TELEPHONE CORPORATION, Tokyo (JP)

(72) Inventors: Toshinori USUI, Musashino-shi, Tokyo (JP); Tomonori IKUSE, Musashino-shi, Tokyo (JP); Yuhei KAWAKOYA, Musashino-shi, Tokyo (JP); Makoto IWAMURA, Musashino-shi, Tokyo (JP); Jun MIYOSHI, Musashino-shi, Tokyo (JP)

(73) Assignee: NIPPON TELEGRAPH AND TELEPHONE CORPORATION, Tokyo (JP)

(21) Appl. No.: 18/280,672

(22) PCT Filed: Mar. 16, 2021
(86) PCT No.: PCT/JP2021/010691

§ 371 Date: Sep. 7, 2023

(51) Int. Cl. G06F 21/56

(52) U.S. Cl. CPC G06F 21/56; G06F 2221/034

(57) ABSTRACT

A trace information determination device includes an extraction unit that extracts a feature of malware, a classification unit that performs clustering on the basis of the feature of malware extracted by the extraction unit and classifies the malware into a predetermined cluster, an attack tendency determination unit that determines a tendency of an attack of the malware on the basis of the cluster classified by the classification unit, and a validity determination unit that determines validity of trace information generated from an activity trace of the malware on the basis of a result of determination by the attack tendency determination unit.

### TECHNICAL FIELD

The present invention relates to a determination device, a determination method, and a determination program.

### BACKGROUND ART

In recent years, with sophistication of malware, malware that is difficult to detect by conventional anti-virus software that detects on the basis of signatures has increased. Further, there is detection by a dynamic analysis sandbox that allows transmitted and received files to operate in an isolated environment for analysis, and detects malware from malignancy of an observed behavior, but it is becoming more common that the environment for analysis is sensed and avoided by a method of viewing the degree of deviation from a general user environment, or the like.

Under such a background, a malware response technology called Endpoint Detection and Response (EDR) has been used. In EDR, a behavior of a terminal is continuously monitored using an agent installed in the terminal of the user instead of the environment prepared for analysis. Then, malware is detected using trace information (indicator of compromise (IOC)) that is prepared in advance and is a signature of behavior, so to speak, for detecting a trace left when the malware was active. Specifically, EDR collates a behavior observed at the terminal with the IOC, and detects that there is a suspicion of malware infection if there is a match.

Therefore, whether or not malware can be detected by EDR depends on whether IOCs useful for detecting certain malware are held. On the other hand, in a case where the IOC matches not only malware but also traces of activity of legitimate software, there is a problem that erroneous detection occurs. Therefore, it is necessary to selectively extract traces that are useful for detection and turn them into IOCs, rather than merely increasing the number by randomly turning malware traces into the IOCs.

Further, also from the viewpoint of IOCs that can be collated by EDR at a time, it is necessary to selectively extract traces that are useful for detection and turn them into the IOCs. That is, since EDR generally takes more time to collate as it has more IOCs, it is desirable to have a combination of IOCs that detect more types of malware with a smaller number of IOCs. At that time, if the IOCs are generated from activity traces that are not useful for detection, it leads to taking unnecessary time for collation.

Nowadays, new malware is created every day, and the IOCs corresponding thereto also continue to change. Thus, in order to continuously cope with them, it is necessary to automatically analyze malware, extract a trace of activity, and generate IOCs. The IOC is generated on the basis of the activity trace obtained by analyzing malware. In general, a trace obtained by executing malware while monitoring its behavior is collected, and the trace is normalized or a combination suitable for detection is selected to thereby obtain the IOC. From the above, a technique for selectively and automatically extracting the activity trace useful for detecting malware is desired.

For example, Non Patent Literature 1 proposes a method of extracting a pattern of traces repeatedly observed among a plurality of malware and using the pattern as an IOC. Further, Non Patent Literature 2 proposes a method of automatically generating an IOC that is easy for humans to understand by extracting a set of traces co-occurring between pieces of malware of the same family and preventing an increase in the complexity of the IOC by a set optimization method. According to these methods, it is possible to automatically extract an IOC that can contribute to malware detection from an execution trace log.

Here, the execution trace is to trace the execution status of a program by sequentially recording behaviors from various viewpoints at the time of execution. Further, a program having a function of monitoring and recording behavior in order to achieve this is called a tracer. For example, a program in which executed application programming interfaces (APIs) are sequentially recorded is referred to as an API trace, and a program for achieving the API trace is referred to as an API tracer.

### CITATION LIST

### Non Patent Literature

Non Patent Literature 1: Christian Doll et al. “Automated Pattern Inference Based on Repeatedly Observed Malware Artifacts.” Proceedings of the 14th International Conference on Availability, Reliability and Security. 2019.
Non Patent Literature 2: Yuma Kurogome et al. “EIGER: Automated IOC Generation for Accurate and Interpretable Endpoint Malware Detection.” Proceedings of the 35th Annual Computer Security Applications Conference. 2019.

### SUMMARY OF INVENTION

### Technical Problem

However, in the above-described prior art, there is a problem that it is not determined in which period the generated IOC should be enabled and in which period the IOC should be disabled. EDR detects malware by sequentially collating IOCs held one by one. Thus, as the number of IOCs increases, the time required for collation also increases. On the other hand, the time and calculation resources required for malware detection are limited to a certain range from the viewpoint of performing inspection at runtime on the user's terminal. Thus, the number of IOCs simultaneously used for inspection is finite, and invalid IOCs that do not contribute to detection should be excluded as much as possible.

There is a trend in malware to which the IOC corresponds mainly for each family, and many are used in association with a specific attack campaign or actor. Then, after the end of the attack campaign or after the actor stops operating the malware, validity of the IOC is often lost. On the other hand, there is also a case where malware that has been hardly seen until then is activated again by the actor who has stopped activity for a certain period restarting the activity. Therefore, invalidating and enabling IOCs used by EDR in accordance with such a trend in malware is an important problem in effectively operating EDR.

### Solution to Problem

In order to solve the above-described problems and achieve the object, a determination device according to the present invention includes an extraction unit that extracts a feature of malware, a classification unit that performs clustering on the basis of the feature extracted by the extraction unit and classifies the malware into a predetermined cluster, an attack tendency determination unit that determines a tendency of an attack of the malware on the basis of the cluster classified by the classification unit, and a validity determination unit that determines validity of trace information generated from an activity trace of the malware on the basis of a result of determination by the attack tendency determination unit.

Further, a determination method according to the present invention is a determination method executed by a determination device, the determination method including an extraction step of extracting a feature of malware, a classification step of performing clustering on the basis of the feature extracted by the extraction step and classifying the malware into a predetermined cluster, an attack tendency determination step of determining a tendency of an attack of the malware on the basis of the cluster classified by the classification step, and a validity determination step of determining validity of trace information generated from an activity trace of the malware on the basis of a result of determination by the attack tendency determination step.

Further, a determination program according to the present invention causes a computer to execute an extraction step of extracting a feature of malware, a classification step of performing clustering on the basis of the feature extracted by the extraction step and classifying the malware into a predetermined cluster, an attack tendency determination step of determining a tendency of an attack of the malware on the basis of the cluster classified by the classification step, and a validity determination step of determining validity of trace information generated from an activity trace of the malware on the basis of a result of determination by the attack tendency determination step.

### Advantageous Effects of Invention

In the present invention, EDR can be operated more effectively by determining validity of a generated IOC.

### BRIEF DESCRIPTION OF DRAWINGS

FIG. 1 is a diagram illustrating a configuration example of a trace information determination system according to a first embodiment.

FIG. 2 is a block diagram illustrating a configuration example of a trace information determination device according to the first embodiment.

FIG. 3 is a diagram illustrating an outline of clustering processing according to the first embodiment.

FIG. 4 is a diagram illustrating an outline of trace information validity determination processing according to the first embodiment.

FIG. 5 is a flowchart illustrating an example of an overall flow of trace information determination processing according to the first embodiment.

FIG. 6 is a flowchart illustrating an example of a flow of attack tendency determination processing according to the first embodiment.

FIG. 7 is a flowchart illustrating an example of a flow of the trace information validity determination processing according to the first embodiment.

FIG. 8 is a diagram illustrating a computer that executes a program.

### DESCRIPTION OF EMBODIMENTS

Hereinafter, embodiments of a trace information determination device (determination device as appropriate), a trace information determination method (determination method as appropriate), and a trace information determination program (determination program as appropriate) according to the present invention will be described in detail with reference to the drawings. Note that the present invention is not limited to the embodiments described below.

### First Embodiment

Hereinafter, a configuration of a trace information determination system, a configuration of the trace information determination device, an outline of clustering processing, an outline of trace information validity determination processing, an overall flow of trace information determination processing, a flow of attack tendency determination processing, and a flow of the trace information validity determination processing according to the present embodiment will be described in order, and finally, effects of the present embodiment will be described.

[Configuration of Trace Information Determination System]

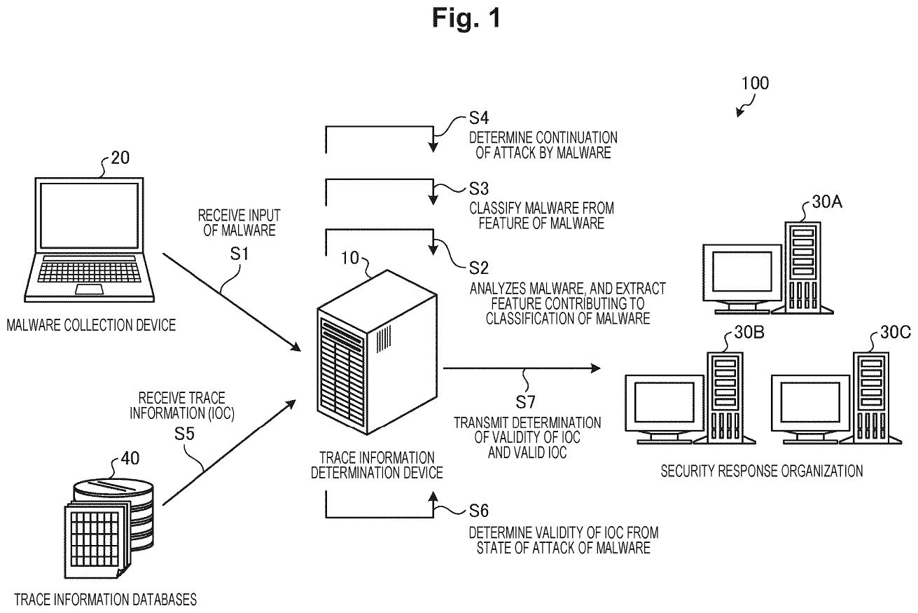

A configuration of a trace information determination system (the present system as appropriate) 100 according to the present embodiment will be described in detail with reference to FIG. 1. FIG. 1 is a diagram illustrating a configuration example of a trace information determination system according to a first embodiment. The present system 100 includes a trace information determination device 10, a malware collection device 20 functioning as a sensor, a security response organization 30 (30A, 30B, and 30C) such as a security operation center (SOC) or a computer security incident response team (CSIRT), and a trace information database 40. Here, the trace information determination device 10, the malware collection device 20, the security response organization 30, and the trace information database 40 are communicably connected in a wired or wireless manner via a predetermined communication network (not illustrated). Note that the trace information determination system 100 illustrated in FIG. 1 may include a plurality of trace information determination devices 10, a plurality of malware collection devices 20, and a plurality of trace information databases 40.

First, the trace information determination device 10 receives an input of malware from the malware collection device 20 (step S1). Here, the malware collection device 20 is a dedicated device that collects information of malware such as a malware sharing service for research such as VirusTotal, a CSIRT in an organization, and a honey pot, but is not particularly limited. The malware collection device 20 may be a personal computer (PC) owned by a user such as a general network, a smartphone, a tablet terminal, or the like.

Next, the trace information determination device 10 analyzes the malware that has received the input and extracts a feature (“feature of malware” or “malware feature” as appropriate) contributing to classification of malware (step S2). At this time, the trace information determination device 10 extracts a feature (for example, API trace or metadata of a file) having a high similarity between subspecies. Note that detailed malware collection processing and malware feature acquisition processing by the trace information determination device 10 will be described later in [Overall flow of trace information determination processing].

A feature such as an API trace or metadata generally has a high similarity between subspecies of malware. Thus, by performing clustering on the basis of such a feature, it can be expected that subspecies of malware are classified into the same cluster. In an attack campaign and an attack by the same actor, since the subspecies of malware is continuously used, it is possible to know the tendency (for example, the continuation status of the attack, and the like) of the attack campaign and the attack by the same actor by continuously viewing the obtained cluster described above.

Subsequently, the trace information determination device 10 classifies the malware from the obtained feature of the malware (step S3). At this time, the trace information determination device 10 performs clustering on the basis of the feature of the malware to create a cluster for each feature. Note that detailed clustering processing by the trace information determination device 10 will be described later in [Outline of clustering processing].

Further, the trace information determination device 10 determines continuation of the attack by the malware (step S4). At this time, the trace information determination device 10 determines a tendency as to whether the attack of the malware classified into the cluster is continuing on the basis of time-series change in the created cluster. Note that detailed attack tendency determination processing by the trace information determination device 10 will be described later in [Flow of attack tendency determination processing].

On the other hand, the trace information determination device 10 receives trace information (IOC) from the trace information database 40 (step S5). Here, the IOC received by the trace information determination device 10 is IOC generated from activity traces of malware collected by the malware collection device 20 in the past, but is not particularly limited.

Then, the trace information determination device 10 determines validity of the IOC from a state of the attack of the malware (step S6). At this time, the trace information determination device 10 determines the validity of the IOC on the basis of states of continuation and termination of the attack of the malware. Detailed IOC validity determination processing by the trace information determination device 10 will be described later in [Flow of trace information validity determination processing].

Finally, the trace information determination device 10 transmits determination of the validity of the IOC and the valid IOC to the security response organization 30 (step S7). The terminal or the like to which the trace information determination device 10 transmits determination and the IOC is not particularly limited.

The trace information determination system 100 according to the present embodiment collects malware reflecting a trend in attacks and acquires information effective for classification by analysis thereof. Then, the malware is clustered on the basis of the information, and it is determined whether the attack by the malware is continuing on the basis of the time-series change of the created cluster. Further, the validity of the IOC is determined on the basis of the states of continuation and termination of the attack. Thus, in the present system 100, it is possible to determine whether or not the trend in attacks by the malware is continuing, and to appropriately disable or enable the IOC of the malware.

Further, the present system 100 is useful for selecting an effective IOC in consideration of the trend in attacks of malware, and is suitable for improving the efficiency of detection by excluding obsolete IOCs no longer used for attacks from detection by EDR. Thus, by selecting the IOC to be input to EDR using the present system 100, it is possible to more effectively operate EDR and take measures against malware effective in SOC, CSIRT, and the like.

[Configuration of Trace Information Determination Device]

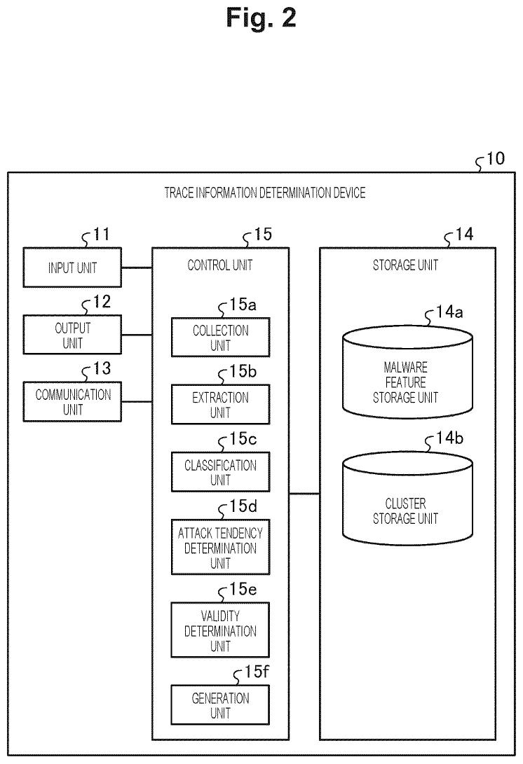

A configuration of the trace information determination device 10 according to the present embodiment will be described in detail with reference to FIG. 2. FIG. 2 is a block diagram illustrating a configuration example of the trace information determination device according to the present embodiment. The trace information determination device 10 includes an input unit 11, an output unit 12, a communication unit 13, a storage unit 14, and a control unit 15.

The input unit 11 is responsible for inputting various types of information to the trace information determination device 10. The input unit 11 is, for example, a mouse, a keyboard, or the like, and receives an input of setting information or the like to the trace information determination device 10. Further, the output unit 12 also controls output of various types of information from the trace information determination device 10. The output unit 12 is, for example, a display or the like, and outputs setting information or the like stored in the trace information determination device 10.

The communication unit 13 controls data communication with other devices. For example, the communication unit 13 performs data communication with each communication device. Further, the communication unit 13 can perform data communication with a terminal of an operator, which is not illustrated.

The storage unit 14 stores various kinds of information referred to when the control unit 15 operates, and stores various types of information acquired when the control unit 15 operates. The storage unit 14 includes a malware feature storage unit 14a and a cluster storage unit 14b. Here, the storage unit 14 is, for example, a semiconductor memory element such as a random access memory (RAM) or a flash memory, a storage device such as a hard disk or an optical disc, or the like. Note that, in the example of FIG. 2, the storage unit 14 is installed inside the trace information determination device 10, but may be installed outside the trace information determination device 10, or a plurality of storage units may be installed.

The malware feature storage unit 14a stores features of malware extracted by an extraction unit 15b of the control unit 15. For example, the malware feature storage unit 14a stores a family name of malware, a name of an attack campaign, and the like. Further, the cluster storage unit 14b stores a cluster generated by processing of a classification unit 15c of the control unit 15. For example, the cluster storage unit 14b stores information regarding clusters classified for each malware family and attack campaign by the clustering processing.

The control unit 15 controls the entire trace information determination device 10. The control unit 15 includes a collection unit 15a, the extraction unit 15b, the classification unit 15c, an attack tendency determination unit 15d, a validity determination unit 15e, and a generation unit 15f. Here, the control unit 15 is, for example, an electronic circuit such as a central processing unit (CPU) or a micro processing unit (MPU), or an integrated circuit such as an application specific integrated circuit (ASIC) or a field programmable gate array (FPGA).

The collection unit 15a collects malware. For example, the collection unit 15a collects malware of a trending family or malware of an ongoing attack campaign as a specimen. Further, the collection unit 15a collects malware information collected by a malware sharing service, a CSIRT, a honey pot, or the like as a specimen.

The extraction unit 15b extracts a feature of malware. For example, the extraction unit 15b extracts a feature having a high similarity between subspecies from malware as a feature of malware. Further, the extraction unit 15b extracts an API trace or metadata of malware by a predetermined method. Note that processing for the extraction unit 15b to extract a feature of malware is not particularly limited. On the other hand, the extraction unit 15b stores the extracted feature of malware in the malware feature storage unit 14a.

The classification unit 15c performs clustering on the basis of the feature of malware extracted by the extraction unit 15b, and classifies the malware into a predetermined cluster. For example, the classification unit 15c classifies the malware into a cluster for each malware family or attack campaign. Further, in a case where the malware is collected by the collection unit 15a, the classification unit 15c updates the classified cluster every time new malware is collected. On the other hand, the classification unit 15c stores information of the classified cluster and the updated cluster in the cluster storage unit 14b.

The attack tendency determination unit 15d determines a tendency of an attack of malware on the basis of the cluster classified by the classification unit 15c. For example, the attack tendency determination unit 15d determines continuity of the attack of the malware as the tendency of the attack of the malware. Further, the detection unit 15d calculates a non-update period for each cluster on the basis of an update history of the cluster, and determines the continuity of the attack of the malware from the non-update period. Note that detailed attack tendency determination processing by the attack tendency determination unit 15d will be described later in [Flow of attack tendency determination processing].

The validity determination unit 15e determines validity of trace information generated from the activity traces of malware on the basis of a result of determination by the attack tendency determination unit 15d. For example, in a case where the non-update period is equal to or more than a predetermined value, the validity determination unit 15e determines that the trace information of malware classified as a cluster is invalid. The detailed trace information validity determination processing by the validity determination unit 15e will be described later in [Flow of trace information validity determination processing].

The generation unit 15f generates valid trace information of malware on the basis of the validity of the trace information determined by the validity determination unit 15e. For example, the generation unit 15f excludes the trace information determined to be invalid by the determination unit 15e, and generates the trace information from only the trace information determined to be valid. In addition, the trace information may be generated by assigning a priority based on the cluster non-update period to the trace information determined to be valid by the determination unit 15e.

[Overview of Clustering Processing]

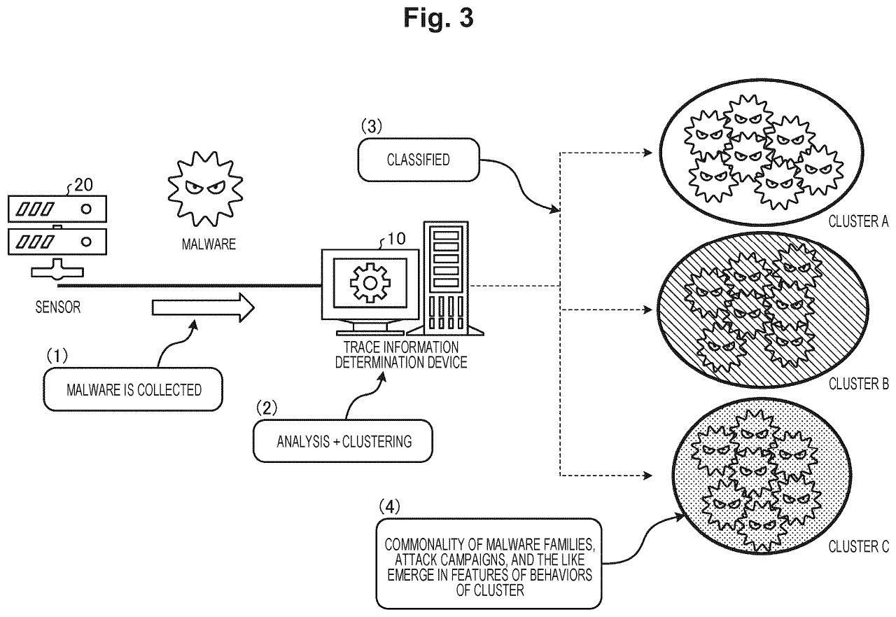

An outline of the clustering processing according to the present embodiment will be described with reference to FIG. 3. FIG. 3 is a diagram illustrating an outline of clustering processing according to the first embodiment.

First, the trace information determination device 10 collects malware via a sensor or the like of the malware collection device 20 (see FIG. 3(1)). Here, the malware collected by the trace information determination device 10 needs to reflect a tendency of attack including an IOC adaptation target organization. For example, a “scattering-type attack” tends to attack globally, and a “target-type attack” tends to attack an organization that adapts the IOC.

Next, the trace information determination device 10 analyzes and clusters the collected malware (see FIG. 3(2)). Then, the trace information determination device 10 generates a plurality of clusters classified for each feature of malware as a result of clustering (see FIG. 3(3)). In FIG. 3, the trace information determination device 10 generates a cluster A, a cluster B, and a cluster C. Among features of behaviors of malware included in each cluster, commonality of malware families, attack campaigns, and the like are seen (see FIG. 3(4)).

Note that, for clustering, a hierarchical method such as Ward's method may be used, or a non-hierarchical method such as K-means may be used. The method is not limited thereto as long as the subspecies of malware can be collected.

[Outline of Trace Information Validity Determination Processing]

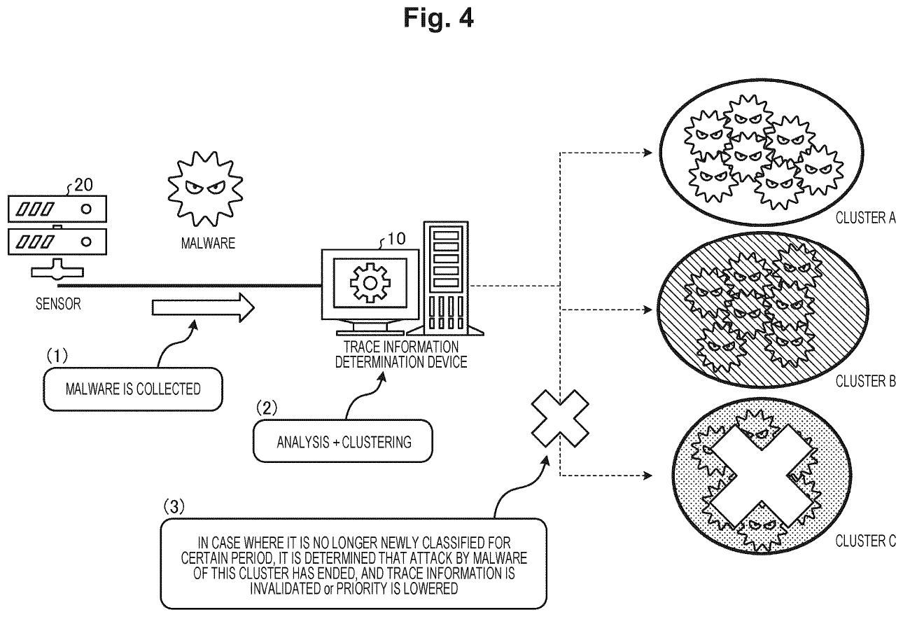

An outline of the trace information validity determination processing according to the present embodiment will be described with reference to FIG. 4. FIG. 4 is a diagram illustrating an outline of the trace information validity determination processing according to the first embodiment.

First, the trace information determination device 10 continuously collects malware via the malware collection device 20 or the like functioning as a sensor (see FIG. 4(1)). Next, the trace information determination device 10 analyzes and clusters the collected malware (see FIG. 4(2)). Then, the trace information determination device 10 generates a plurality of clusters classified for each feature of malware as a result of clustering, and updates the cluster every time new malware is collected. Then, in a case where a cluster in which malware is no longer classified newly appears for a certain period, the trace information determination device 10 determines that the attack by the malware of the cluster has ended, and invalidates the IOC or lowers the priority (see FIG. 4(3)). In FIG. 4, since the trace information determination device 10 generates and updates the cluster A, the cluster B, and the cluster C and no new malware is classified into the cluster C for a certain period of time, it is determined that the IOC of the malware classified into the cluster C is invalid.

[Overall Flow of Trace Information Determination Processing]

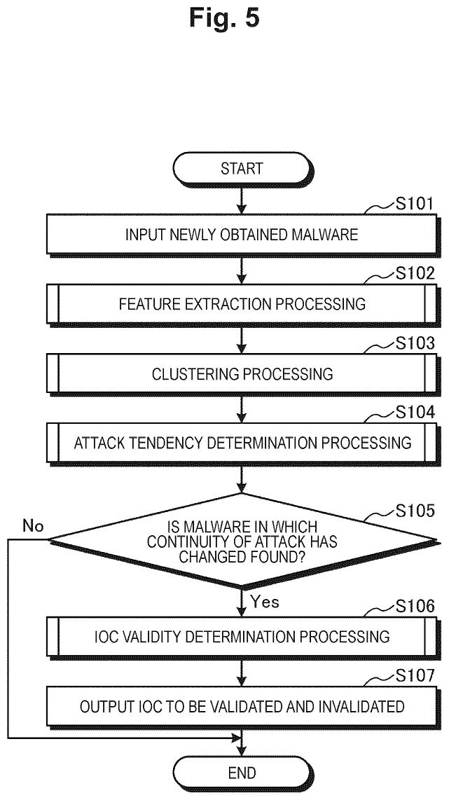

The overall flow of the trace information determination processing according to the present embodiment will be described in detail with reference to FIG. 5. FIG. 5 is a flowchart illustrating an example of the overall flow of trace information determination processing according to the first embodiment.

First, the collection unit 15a of the trace information determination device 10 receives an input of malware as a target for which the validity of the trace information (IOC) is determined from the malware collection device 20 (step S101). At this time, the collection unit 15a may collect information of the malware from a device other than the malware collection device 20. In addition, the collection unit 15a may collect information of the malware directly input via the input unit 11.

(Feature Extraction Processing)

The extraction unit 15b analyzes malware in order to extract a feature (feature of malware) contributing to the classification of malware (step S102). Here, the feature of malware is an API trace, metadata of a file, or the like, and is a feature that contributes to classification reflecting subspecies, but is not particularly limited. For example, the extraction unit 15b executes malware in an isolated environment, and extracts the feature of malware from the API trace in which a called API is recorded together with an argument and a return value. Further, the extraction unit 15b performs metadata extraction to investigate the value of a header portion of a file of the malware and extracts the feature of the malware.

(Clustering Processing)

The classification unit 15c performs clustering on the basis of the feature (for example, the API trace and the metadata of the file) of malware extracted by the extraction unit 15b, and classifies the malware into clusters (step S103). Further, in a case where the malware is collected by the collection unit 15a, the classification unit 15c updates the classified cluster every time new malware is collected.

(Attack Tendency Determination Processing)

The attack tendency determination unit 15d determines the tendency of the attack of the malware on the basis of the cluster classified by the classification unit 15c (step S104). Here, the tendency of the attack of the malware is, for example, the continuity of the attack of the malware or the like, but is not particularly limited, and may be the total number of pieces of malware, an attack target, an attack type, or the like. Further, the attack tendency determination unit 15d calculates a non-update period for each cluster on the basis of an update history of the cluster, and determines the continuity of the attack of the malware from the non-update period. Note that detailed attack tendency determination processing by the attack tendency determination unit 15d will be described later in [Flow of attack tendency determination processing].

At this time, in a case where malware in which the tendency of the attack such as the continuity of the attack has changed is found (step S105: Yes), the attack tendency determination unit 15d proceeds to the IOC validity determination processing in step S106. On the other hand, in a case where malware in which the continuity of the attack has changed is not found (step S105: No), the attack tendency determination unit 15d ends the processing.

(IOC Validity Determination Processing)

The validity determination unit 15e determines the validity of the trace information (IOC) of the malware on the basis of the attack tendency determined in step S104 (step S106). At this time, the validity determination unit 15e may transmit a determination result to the security response organization 30 via the communication unit 13. The detailed IOC validity determination processing by the validity determination unit 15e will be described later in [Flow of trace information validity determination processing].

Finally, the generation unit 15f outputs an IOC to be validated and an IOC to be invalidated on the basis of the validity of the IOC determined in step 3106 (step 3107), and ends the processing. At this time, the generation unit 15f may display the generated IOC via the output unit 12. In addition, the generation unit 15f may transmit the IOC generated to the security response organization 30 via the communication unit 13.

[Flow of Attack Tendency Determination Processing]

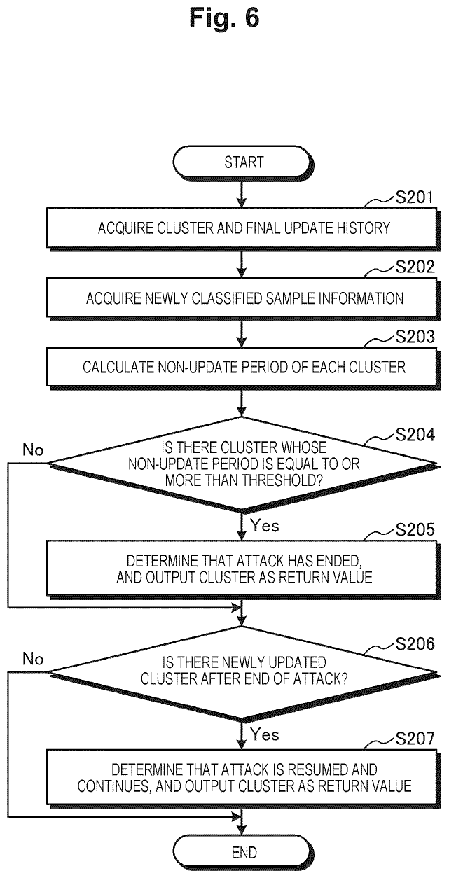

A flow of the attack tendency determination processing according to the present embodiment will be described in detail with reference to FIG. 6. FIG. 6 is a flowchart illustrating an example of the flow of the attack tendency determination processing according to the first embodiment. First, the attack tendency determination unit 15d of the trace information determination device 10 acquires cluster information and a final update history for each cluster from the cluster storage unit 14b (step S201). At this time, the attack tendency determination unit 15d may acquire the cluster information and the final update history for each cluster from other than the cluster storage unit 14b. In addition, the attack tendency determination unit 15d may acquire the cluster information and the final update history for each cluster directly input via the input unit 11.

Next, the attack tendency determination unit 15d acquires newly classified sample information from the classification unit 15c (step S202). Here, the sample information is information indicating to which cluster the newly collected malware belongs, but is not particularly limited. At this time, the attack tendency determination unit 15d may acquire new sample information from the cluster storage unit 14b.

Subsequently, the attack tendency determination unit 15d calculates a non-update period of each cluster (step S203), and in a case where there is a cluster whose non-update period is equal to or more than a threshold (step S204: Yes), it is determined that the attack of the malware has ended, and the corresponding cluster is output as a return value (step S205). On the other hand, in a case where there is no cluster whose non-update period is equal to or more than the threshold (step S204: No), the attack tendency determination unit 15d proceeds to step S206.

Finally, in a case where there is a newly updated cluster even though it is a cluster in which it has been determined that the attack has ended in the past (step S206: Yes), the attack tendency determination unit 15d determines that the attack of the malware classified into the corresponding cluster is resumed and the attack continues, outputs the corresponding cluster as a return value (step S207), and ends the processing. On the other hand, in a case where there is no newly updated cluster among clusters in which it has been determined that the attack have ended in the past (step S206: No), the attack tendency determination unit 15d ends the processing.

[Flow of Trace Information Validity Determination Processing]

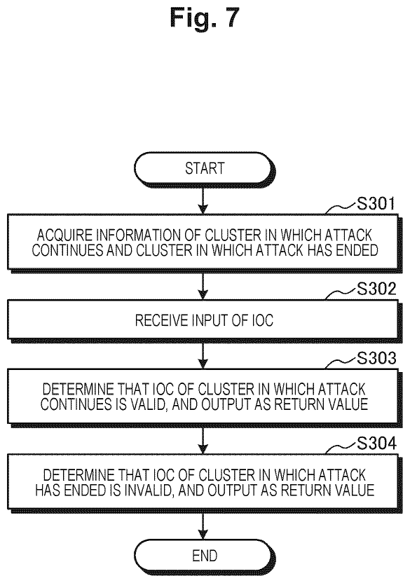

A flow of the trace information validity determination processing according to the present embodiment will be described in detail with reference to FIG. 7. FIG. 7 is a flowchart illustrating an example of the flow of the trace information validity determination processing according to the first embodiment. First, the validity determination unit 15e of the trace information determination device 10 acquires, from the attack tendency determination unit 15d, information of a cluster in which the attack continues and a cluster in which the attack has ended (step S301). Further, the validity determination unit 15e receives an input of trace information (IOC) from the trace information database 40 (step S302). At this time, the validity determination unit 15e may receive an input of the IOC from a source other than the trace information database 40. Note that the processing in step S301 and the processing in step S302 may be performed simultaneously. In addition, the processing of step S302 may be performed before the processing of step S301.

Next, the validity determination unit 15e determines that the IOC of the cluster in which the attack continues is valid, and outputs the corresponding IOC as a return value (step S303). Further, the validity determination unit 15e determines that the IOC of the cluster in which the attack has ended is invalid, outputs the corresponding IOC as a return value (step S304), and ends the processing. Note that the processing in step S303 and the processing in step S304 may be performed simultaneously. In addition, the processing of step S304 may be performed before the processing of step S303.

[Effects of First Embodiment]

First, in the trace information determination processing according to the present embodiment described above, the feature of malware is extracted, clustering is performed on the basis of the extracted feature of malware, the malware is classified into a predetermined cluster, a tendency of an attack of the malware is determined on the basis of the classified cluster, and validity of the trace information (IOC) generated from an activity trace of the malware is determined on the basis of a determination result. Thus, in this process, the EDR can be more effectively operated by determining the validity of the generated IOC.

Second, in the trace information determination processing according to the present embodiment described above, a feature having a high similarity between subspecies is extracted from malware as the feature of the malware. Thus, in this process, the EDR can be more effectively operated by determining the validity of the generated IOC in consideration of the similarity of the malware.

Third, in the trace information determination processing according to the present embodiment described above, the API trace or the metadata of the malware is extracted as the feature of the malware, the malware is classified into a cluster for each malware family or attack campaign, and continuity of the attack of the malware is determined as the tendency of the attack of the malware. Thus, in this process, the EDR can be more effectively operated by determining the validity of the generated IOC in consideration of the trend in malware.

Fourth, in the trace information determination processing according to the present embodiment described above, malware is collected, and in a case where malware is collected, the classified cluster is updated every time new malware is collected, the non-update period for each cluster is calculated on the basis of the update history of the cluster, and the continuity of the attack is determined from the non-update period, and in a case where the non-update period is equal to or more than a predetermined value, the trace information of the malware classified into the cluster is determined to be invalid. In this processing, the EDR can be more effectively operated by more quickly determining the validity of the generated IOC in consideration of the trend in malware.

Fifth, in the trace information determination processing according to the present embodiment described above, valid trace information of malware is generated on the basis of the determined validity of the IOC. In this processing, the EDR can be more effectively operated by more quickly determining the validity of the generated IOC and generating the effective IOC in consideration of the trend in malware.

[System Configuration or the Like]

Each component of each device that has been illustrated according to the embodiment described above is functionally conceptual and does not necessarily have to be physically configured as illustrated. In other words, a specific form of distribution and integration of individual devices is not limited to the illustrated form, and all or part of the configuration can be functionally or physically distributed and integrated in any unit according to various loads, usage conditions, and the like. Further, all or any part of each processing function performed in each device can be implemented by a CPU and a program to be analyzed and executed by the CPU or can be implemented as hardware by wired logic.

Further, among the individual processing described in the embodiment described above, all or part of the processing described as being automatically performed can be manually performed, or all or part of the processing described as being manually performed can be automatically performed by a known method. In addition, the processing procedure, the control procedure, the specific name, and the information including various data and parameters that are illustrated in the document and the drawings can be freely changed unless otherwise specified.

[Program]

Further, it is also possible to create a program in which the processing executed by the trace information determination device 10 described in the above embodiment is described in a language that can be executed by a computer. In this case, the computer executes the program, and thus the effects similar to those of the embodiment described above can be obtained. Furthermore, the program may be recorded in a computer-readable recording medium, and the program recorded in the recording medium may be read and executed by the computer to implement processing similar to the embodiment described above.

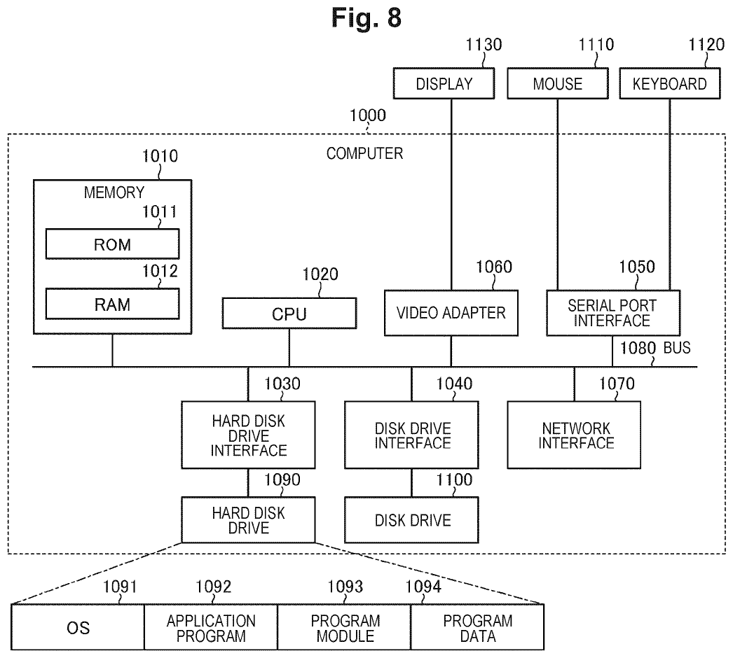

FIG. 8 is a diagram illustrating a computer that executes a program. As exemplified in FIG. 8, a computer 1000 includes, for example, memory 1010, a CPU 1020, a hard disk drive interface 1030, a disk drive interface 1040, a serial port interface 1050, a video adapter 1060, and a network interface 1070, and these units are connected by a bus 1080.

As exemplified in FIG. 8, the memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090 as exemplified in FIG. 8. The disk drive interface 1040 is connected to a disk drive 1100 as exemplified in FIG. 8. For example, a removable storage medium such as a magnetic disk or an optical disk is inserted into the disk drive 1100. As exemplified in FIG. 8, the serial port interface 1050 is connected to, for example, a mouse 1110 and a keyboard 1120. As exemplified in FIG. 8, the video adapter 1060 is connected to, for example, a display 1130.

Here, as exemplified in FIG. 8, the hard disk drive 1090 stores, for example, an OS 1091, an application program 1092, a program module 1093, and program data 1094. In other words, the above program is stored, for example, in the hard disk drive 1090 as a program module in which a command to be executed by the computer 1000 is described.

Further, various data described in the embodiment described above is stored as program data in, for example, the memory 1010 and the hard disk drive 1090. Then, the CPU 1020 reads out the program module 1093 and the program data 1094 stored in the memory 1010 and the hard disk drive 1090 to the RAM 1012 as necessary and executes various processing procedures.

Note that the program module 1093 and the program data 1094 related to the program are not limited to being stored in the hard disk drive 1090 and may be stored in, for example, a removable storage medium and may be read by the CPU 1020 via a disk drive, or the like. Alternatively, the program module 1093 and the program data 1094 related to the program may be stored in another computer connected via a network (such as a local area network (LAN) or a wide area network (WAN)) and may be read by the CPU 1020 via the network interface 1070.

The embodiment described above and modifications thereof are included in the inventions recited in the claims and the equivalent scope thereof, similarly to being included in the technique disclosed in the present application.

### REFERENCE SIGNS LIST

10 Trace information determination device (determination device)
11 Input unit
12 Output unit
13 Communication unit
14 Storage unit
14a Malware feature storage unit
14b Cluster storage unit
15 Control unit
15a Collection unit
15b Extraction unit
15c Classification unit
15d Attack tendency determination unit
15e Validity determination unit
15f Generation unit
20 Malware collection device
30, 30A, 30B, 30C Security response organization
40 Trace information database
100 Trace information determination system

1. A determination device, comprising:
extraction circuitry that extracts a feature of malware;
classification circuitry that performs clustering on a basis of the feature extracted by the extraction circuitry and classifies the malware into a predetermined cluster;
attack tendency determination circuitry that determines a tendency of an attack of the malware on a basis of the cluster classified by the classification circuitry; and
validity determination circuitry that determines validity of trace information generated from an activity trace of the malware on a basis of a result of determination by the attack tendency determination circuitry.

2. The determination device according to claim 1, wherein:
the extraction circuitry extracts, as the feature, a feature having a high similarity between subspecies from the malware.

3. The determination device according to claim 1, wherein:
the extraction circuitry extracts, as the feature, an application programming interface (API) trace or metadata of the malware by a predetermined method,
the classification circuitry classifies the malware into a cluster for each family or attack campaign, and
the attack tendency determination circuitry determines continuity of the attack of the malware as the tendency of the attack.

4. The determination device according to claim 1, further comprising:
collection circuitry that collects the malware,
wherein:
in a case where the malware is collected by the collection circuitry, the classification circuitry updates the cluster every time new malware is collected,
the attack tendency determination circuitry calculates a non-update period for each of the clusters on a basis of an update history of the cluster, and determines the continuity of the attack from the non-update period, and
in a case where the non-update period is equal to or more than a predetermined value, the validity determination circuitry determines that the trace information of the malware classified into the cluster is invalid.

5. The determination device according to claim 1, further comprising:
generation circuitry that generates valid trace information of the malware on a basis of the validity determined by the determination circuitry.

6. A determination method, comprising:
an extraction step of extracting a feature of malware;
a classification step of performing clustering on a basis of the feature extracted by the extraction step and classifying the malware into a predetermined cluster;
an attack tendency determination step of determining a tendency of an attack of the malware on a basis of the cluster classified by the classification step; and
a validity determination step of determining validity of trace information generated from an activity trace of the malware on a basis of a result of determination by the attack tendency determination step.

7. A non-transitory computer readable medium storing a determination program for causing a computer to execute:
an extraction step of extracting a feature of malware;
a classification step of performing clustering on a basis of the feature extracted by the extraction step and classifying the malware into a predetermined cluster;
an attack tendency determination step of determining a tendency of an attack of the malware on a basis of the cluster classified by the classification step; and
a validity determination step of determining validity of trace information generated from an activity trace of the malware on a basis of a result of determination by the attack tendency determination step.
